(19) United States
(12) Patent Application Publication
(10) Pub. No.: US 2025/0066219 A1
(43) Pub. Date: Feb. 27, 2025

(54) Process For The Preparation Of Solid Ferumoxytol

(71) Applicant: Navinta, LLC, Ewing, NJ (US)

(72) Inventors: Pankaj Vasudev Parmar, Vadodara (IN); John Muthiah Raja Jeyakumar, Vadodara (IN); Pratish Valjibhai Dadhaniya, Vadodara (IN); Chirag Vasantial Shah, Vadodara (IN); Bhaveshpari Rajeshpari Gosai, Vadodara (IN); Paresh Raghavbhai Kachhadiya, Rajkot (IN)

(21) Appl. No.: 18/810,906

(22) Filed: Aug. 21, 2024

Related U.S. Application Data
(60) Provisional application No. 63/534,031, filed on Aug. 22, 2023.

(51) Int. Cl. C01G 49/08

(52) U.S. Cl. CPC C01G 49/08

(57) ABSTRACT

An improved process is provided for preparation of ferumoxytol in a solid form with a desired molecular weight. The disclosed process is simple, cost effective and provides preparation of a solid ferumoxytol by using rapid addition of ammonium hydroxide at a suitable time interval and isolation of solid ferumoxytol using a suitable organic solvent.

### FIELD OF THE INVENTION

The present invention relates to an improved process for the preparation of ferumoxytol. Particularly, the present invention relates to a commercially feasible, facile and robust process to prepare a pharmaceutically acceptable ferumoxytol. More particularly, the present invention relates to an improved process for the preparation of a solid ferumoxytol, which involves a rapid addition of ammonium hydroxide at a suitable time interval and isolation of solid ferumoxytol using a suitable organic solvent.

### BACKGROUND OF THE INVENTION

Ferumoxytol (Brand Name: FERAHEME®) was first approved by USFDA in 2009 for the treatment of iron deficiency anemia in patients with chronic kidney disease. Ferumoxytol is a non-stoichiometric magnetite (superparamagnetic iron oxide) coated with polyglucose sorbitol carboxymethylether.

Ferumoxytol was first disclosed in U.S. Pat. No. 6,599,498 as an enhanced magnetic resonance imaging agent and a hematinic agent, comprising carboxyalkylated reduced polysaccharide coated ultrasmall superparamagnetic iron oxides. The process described in this patent has several drawbacks. It was found that material produced by the process is not stable and is very difficult to reproduce over time. Additionally, ferumoxytol is obtained in liquid form and the process requires use of ultrafiltration technique for the removal of foreign particles, which increases both cost and time.

CN 105597105 discloses a method for preparation of ferumoxytol by reducing dextran 10 with sodium borohydride followed by treatment with halogenated acetic acid to obtain polydextrose sorbitol carboxymethyl ether (PSC). Polydextrose sorbitol carboxymethyl is further mixed with ferrous chloride and ferric chloride in water in presence of oxygen or air to obtain ferumoxytol. The drawbacks associated with the disclosed process include the use of ultrafiltration membrane techniques for the removal of foreign particles, which increases cost and time and that obtained ferumoxytol is in liquid form.

Bo Chen et al. (Materials Letters, 2016, 170, 93-96) discloses a process for preparation of ferumoxytol by dissolving polydextrose sorbitol carboxymethyl ether (PSC) in ultrapure water. FeCl₂·4H₂O and FeCl₃·6H₂O are dissolved in ultrapure water, followed by mixing with PSC solution with vigorous mechanical stirring followed by nitrogen bubbling. Ammonium hydroxide is added to the reaction mass and the mass is heated with moderate radio frequency heating machine. The temperature is maintained for 1 hr followed with bubbled air. Finally, the deep-red mixture is obtained which was allowed to cool at room temperature followed by dialysis and ultrafiltration to obtain ferumoxytol. The process described in this publication has certain drawbacks, including the use of dialysis and ultrafiltration technique to obtain ferumoxytol, which increases cost and time. Further, radio frequency heating technique is not viable on a commercial scale.

CN 106137951 discloses a process for obtaining a solid ferumoxytol by spray drying. There are drawbacks observed in the disclosed process including poor reproducibility, use of spray drying technique, and dialysis process making the process very costly.

IN 202121004060 discloses a process for the preparation of solid ferumoxytol without use of ammonia. The drawbacks of the disclosed process are that an undesired iron complex impurity is formed without use of ammonia.

IN 202141027091 discloses a process for the preparation of ferumoxytol by using ammonium chloride and sodium hydroxide. The drawbacks associated with this process include the need for a multi-step process for the preparation of ferumoxytol and the use of sodium hydroxide, which produces ferumoxytol with undesired impurities.

Hence, there is need to develop an alternative process for the preparation of ferumoxytol, which is simple, viable on a commercial scale, cost effective and provides ferumoxytol product as a solid powder having desired molecular weight.

The present inventors have found an improved process for the preparation of solid ferumoxytol, which fulfills the aforesaid objectives.

### SUMMARY OF THE INVENTION

A process for preparation of a solid ferumoxytol is provided, which includes the steps of:
a) reacting a carbohydrate with a mixture of iron salts; and
b) adding ammonium hydroxide in about five minutes or less to obtain a ferumoxytol solution.

In further embodiments, the process for preparation of a solid ferumoxytol further includes the steps of:
c) optionally, distilling out excess ammonium hydroxide and water, and
d) treating the ferumoxytol solution with an organic solvent to obtain a solid ferumoxytol.

In some embodiments, a process for preparation of a solid ferumoxytol is provided, including the steps of: (a) reacting polyglucose sorbitol carboxymethylether (PSC) with a mixture of ferric chloride hexahydrate and ferrous chloride tetrahydrate solution, (b) rapidly adding ammonium hydroxide at a suitable time interval, (c) optionally, distilling out excess ammonium hydroxide and water, and (d) treating the ferumoxytol solution with an organic solvent to obtain a solid ferumoxytol.

In certain embodiments, the process also includes the step of purifying the solid ferumoxytol obtained in step (d) by using a mixture of water and water miscible organic solvent. The water miscible organic solvent may be selected from methanol, isopropanol, acetone, tetrahydrofuran or a mixture thereof.

In some embodiments, the obtained solid ferumoxytol has polydispersity of less than about 1.4. In further embodiments, the obtained solid ferumoxytol has an average molecular weight in a range from about 150,000 to about 270,000 Daltons.

The suitable time interval for addition of ammonium hydroxide may range from about thirty seconds to about five minutes. In some embodiments, the suitable time interval is less than about two minutes.

In certain embodiments, suitable carbohydrate used in step (a) is polyglucose sorbitol carboxymethylether (PSC).

In certain embodiments, suitable iron salt used in step (a) is selected from ferric chloride, ferrous chloride, ferric nitrate, ferrous nitrate, ferric sulfate, ferrous sulfate, ferric bromide, ferrous bromide or mixture thereof. In some preferred embodiments, the iron salt is mixture of ferric chloride hexahydrate and ferrous chloride tetrahydrate.

In certain embodiments, the organic solvent used in step (d) is a water miscible organic solvent. In some of these embodiments, the water miscible organic solvent is selected from methanol, ethanol, isopropanol, acetone, acetonitrile, tetrahydrofuran, dioxane, dimethyl formamide, dimethylacetamide, N-methyl pyrrolidinone or a mixture thereof. In some preferred embodiments, the water miscible organic solvent is N-methyl pyrrolidinone.

A process for purification of a solid ferumoxytol is also provided, including the steps of (a) dissolving the solid ferumoxytol in water, (b) adding a water miscible organic solvent, and (c) isolating a pure solid ferumoxytol.

In some embodiments, the water miscible organic solvent used in step (b) is selected from isopropanol, acetone, tetrahydrofuran or a mixture thereof.

The invention further comprises a process for purification of a solid ferumoxytol, including the steps of (a) adding the solid ferumoxytol into a mixture of water and water miscible organic solvent under stirring at a specific temperature, and (b) isolating a pure solid ferumoxytol.

In some embodiments, the specific temperature is in a range from about 20° C. to about 60° C.

The water miscible organic solvent used in step (a) may be selected from methanol, ethanol, isopropanol, acetone, acetonitrile, tetrahydrofuran, or a mixture thereof.

Other features and advantages of the present invention will become apparent from the following more detailed description, which illustrates, by way of example, the principle of the invention.

### DETAILED DESCRIPTION OF THE INVENTION

The following detailed description is merely exemplary in nature and is not intended to limit the disclosed invention described herein. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

“At least one”, as used herein, relates to one or more, i.e., 1, 2, 3, 4, 5, 6, 7, 8, 9, or more. If used in combination with a compound, the term does not relate to the absolute number of molecules but rather to the number of different types of said compound.

The term “substantially”, as used herein, means at least about 80%, preferably at least about 90%, more preferably at least about 99%, for example at least about 99.9%. In some embodiments, the term substantially can mean completely, or about 100%.

As used herein, the term “comprising” means including, made up of, composed, characterized by or having.

The term “weight average molecular weight,” unless otherwise indicated, means one expression of the molecular weight of a substance which comprises a distribution of molecular weights rather than a single molecular weight. The “weight average molecular weight” is calculated as a summation of the squares of the weights of a fraction of the molecular weight distribution, divided by the total weight of the molecules. The weight average molecular weight may be determined by gel permeation chromatography (GPC), using refractive index, light scattering, small angle neutron scattering (SANS), or by sedimentation velocity.

The term “alkali metal” as used herein refers to metals or ions of metals found in Group I of the periodic table. Preferred alkali metals include, but are not limited to, lithium, sodium and potassium.

The term “base” as used herein refers to a chemical species that donates electrons or hydroxide ions (Arrhenius definition) or that accepts protons (Brönsted definition). Bases include strong bases, i.e., bases that are completely dissociated in aqueous solution and weak bases, i.e., bases that are only partially dissociated in aqueous solution. Examples of strong bases include, but are not limited to, sodium hydroxide and potassium hydroxide. Examples of weak bases include, but are not limited to, ammonia and alkyl amines.

The term “water-miscible organic solvent,” unless otherwise indicated, refers to an organic solvent which is soluble in water in all proportions at standard temperature and pressure. Suitable water-miscible organic solvents include, but are not limited to, methanol, ethanol, isopropanol, acetone, acetonitrile, tetrahydrofuran, dioxane, dimethyl formamide, dimethylacetamide and N-methyl pyrrolidinone.

The terms “aqueous medium” and “aqueous solvent” refer, unless otherwise indicated, to a solvent or medium that is water, or a mixture of water and one or more water-miscible organic solvents.

One embodiment of the present invention provides a process for preparation of a solid ferumoxytol, which includes the steps of:
a) reacting a carbohydrate with a mixture of iron salts; and
b) adding ammonium hydroxide in about five minutes or less to obtain a ferumoxytol solution.

In further embodiments, the process for preparation of a solid ferumoxytol further includes the steps of:
c) optionally, distilling out excess ammonium hydroxide and water, and
d) treating a ferumoxytol solution with an organic solvent to obtain a solid ferumoxytol.

Yet another embodiment of the present invention provides an improved process for preparation of a solid ferumoxytol, which includes the steps of (a) reacting isolated polyglucose sorbitol carboxymethylether (PSC) with a mixture of ferric chloride hexahydrate and ferrous chloride tetrahydrate solution; (b) rapid addition of ammonium hydroxide at a suitable time interval to get ferumoxytol solution; (c) optionally, distilling out excess ammonium hydroxide and water; and (d) treating ferumoxytol solution with an organic solvent to get ferumoxytol in a solid form; and (e) optionally, purifying the solid ferumoxytol obtained in step (d) by using a mixture of water and water miscible organic solvent.

In another embodiment of the present invention, an improved process for preparation of solid ferumoxytol, includes rapid addition of ammonium hydroxide at a suitable time interval of less than about five minutes.

The suitable time interval used during the rapid addition of ammonium hydroxide may be in a range from about thirty seconds to about 5 minutes, preferably from about forty seconds to about three minutes, and more preferably less than about two minutes. It is understood that range of rapid addition may be dependent on different batch scales. Therefore, invention in its broader aspects is not limited to the specific details.

The suitable carbohydrate used in step (a) is polyglucose sorbitol carboxymethylether (PSC).

The suitable iron salts used in step (a) is selected from ferric chloride, ferrous chloride, ferric nitrate, ferrous nitrate, ferric sulfate, ferrous sulfate, ferric bromide, ferrous bromide or mixture thereof, preferably iron salt is mixture of ferric chloride hexahydrate and ferrous chloride tetrahydrate.

The suitable organic solvent used in step (d) may be a water miscible organic solvent, wherein the water miscible organic solvent may include, but is not limited to, methanol, ethanol, isopropanol, acetone, acetonitrile, tetrahydrofuran, dioxane, dimethyl formamide, dimethylacetamide, N-methyl pyrrolidinone or a mixture thereof, preferably is N-methyl pyrrolidinone, ethanol, methanol or a mixture thereof, and more preferably is N-methyl pyrrolidinone.

The water miscible organic solvent used in step (e) is selected from methanol, isopropanol, acetone, tetrahydrofuran or a mixture thereof.

Surprisingly, it was observed that slow addition of ammonium hydroxide results in a compound with higher average molecular weight and higher polydispersity, while rapid addition of ammonium hydroxide results in complexes with a desired molecular weight range from about 150,000 to 270,000 Daltons and a desired polydispersity in a range of less than about 1.4.

Yet another embodiment of the present invention provides an improved process for preparation of ferumoxytol, which includes rapid addition of ammonium hydroxide into reaction mixture of polyglucose sorbitol carboxymethylether (PSC), ferric chloride hexahydrate and ferrous chloride tetrahydrate in less than five minutes to obtain a solid ferumoxytol having a polydispersity of less than about 1.4.

An additional embodiment of the present invention provides a process for purification of a solid ferumoxytol, which includes the steps of: (a) dissolving a solid ferumoxytol in water; (b) adding a water miscible organic solvent; and (c) isolating a pure solid ferumoxytol.

The water miscible organic solvent used for the purification of the solid Ferumoxytol in step (b) may be selected from isopropanol, acetone, tetrahydrofuran or a mixture thereof.

Yet another embodiment of the present invention provides a process for purification of a solid ferumoxytol, including the steps of: (a) adding a solid ferumoxytol into a mixture of water and water miscible organic solvent under stirring at a specific temperature; and (b) isolating a pure solid ferumoxytol.

The specific temperature used in step (a) may be in a range from about 20 to about 60° C.

The water miscible organic solvent used in step (a) may be selected from methanol, ethanol, isopropanol, acetone, acetonitrile, tetrahydrofuran, or a mixture thereof.

The average molecular weight of the isolated ferumoxytol may be in a range from about 150,000 to about 300,000 Daltons, preferably, in a range from about 150,000 to about 285,000 Daltons, and more preferably in a range from about 150,000 to about 270,000 Daltons.

The molecular weight in accordance with the present invention may be measured by using Gel permeation chromatography (GPC) by using appropriate standard as per general method disclosed in U.S. Pat. No. 7,674,780.

### EXAMPLES

### Example 1: Preparation of Polyglucose Sorbitol Carboxymethylether (PSC)

Dextran 10 (100 g) was dissolved in 500 ml of water. 1.25 g of sodium hydroxide and 10 g of sodium borohydride were added, while keeping the reaction temperature between about 40° C. to about 45° C. The mixture was stirred for about 4 hours at about 40° C. to about 45° C. and 100 g of sodium hydroxide and 75 g of bromoacetic acid were added. The mixture was stirred for another 16 hours at about 40° C. to about 45° C. The reaction was quenched by adding concentrated hydrochloric acid (210 mL) into the reaction mixture. The reaction mixture was added to 4000 mL of methanol at about 25° C. to about 30° C. The precipitated solid was filtered to get wet material. The wet material was again dissolved in 400 ml of water and isolated by adding 2000 mL of methanol. The precipitated solid was filtered to get wet material. The wet material was dried at about 40° C. to about 60° C. to obtain 108 g of polyglucose sorbitol carboxymethylether (PSC).

### Example 2: Preparation of Polyglucose Sorbitol Carboxymethylether (PSC)

Dextran 10 (100 g) was dissolved in 500 ml of water, and 1.25 g of sodium hydroxide and 10 g of sodium borohydride were added at about 40° C. to about 45° C. The mixture was stirred for about 4 hours at 40° C. to 45° C. 100 g of sodium hydroxide and 50 g of bromoacetic acid were added to the reaction mixture. The mixture was stirred for 16 hours at 40° C. to 45° C. Concentrated hydrochloric acid (180 mL) was then added into the reaction mixture. The reaction mass was added in to 4000 mL of methanol at 25° C. to 30° C. The precipitate solid was filtered to get wet material. The wet material was again dissolved in 400 ml of water and isolated by adding 2000 mL of methanol. The precipitate solid was filtered to get wet material. The wet material was dried at 40° C. to 60° C. to obtain 91 g of polyglucose sorbitol carboxymethylether (PSC).

### Example 3: Preparation of Ferumoxytol in Solid Form

Polyglucose sorbitol carboxymethylether (PSC) (100 g) as obtained in Example 1 was dissolved in 2000 ml of water at about 65-70° C. Separately, iron solution was prepared by dissolving 66.67 g of ferric chloride hexahydrate and 33.33 g of ferrous chloride tetrahydrate in 400 ml of water at ambient temperature. The iron solution was added into the polyglucose sorbitol carboxymethylether (PSC) solution and kept at 65° C. to 70° C. Ammonium hydroxide solution (1200 g) was added to the reaction at 65° C. to 70° C. within 45 seconds and maintained at 65° C. to 70° C. temperature for 12 hours. The solution was cooled to 25° C. to 30° C. and purged with air for 30 minutes and filtered through 0.2-micron filter. N-methyl pyrrolidinone was added under stirring at 25° C. to 35° C. to precipitate the solid ferumoxytol. The mixture was stirred for 30 minutes and filtered to get Ferumoxytol wet solid which was dried at 50° C. to 60° C. Dry wt.: 33.3 g; Molecular weight: 257000 Daltons; Polydispersity (PDI): 1.26.

### Example 4: Preparation of Ferumoxytol in Solid Form

Polyglucose sorbitol carboxymethylether (PSC) (100 g) as obtained in Example 1 was dissolved in 2000 mL of water at about 65-70° C. Separately, iron solution was prepared by dissolving 73.33 g of ferric chloride hexahydrate and 36.67 g of ferrous chloride tetrahydrate in 400 ml of water at ambient temperature. The iron solution was added into the polyglucose sorbitol carboxymethylether (PSC) solution and kept at about 65° C. to 70° C. Ammonium hydroxide solution (1200 g) was added to the reaction mass at 65° C. to 70° C. within 40 seconds and maintained at 65° C. to 70° C. temperature for about 12 hours. The solution was cooled to about 25° C. to 30° C. and purged with air for about 30 minutes and filtered through 0.2-micron filter. Methanol was added under stirring at 25° C. to 35° C. to precipitate the solid ferumoxytol. The mixture was stirred for 30 minutes and filtered to get Ferumoxytol wet solid which was dried at 50° C. to 60° C. Dry wt.: 67.83 g; Molecular weight: 244000 Daltons; Polydispersity (PDI): 1.26.

### Example 5: Preparation of Ferumoxytol in Solid Form

Polyglucose sorbitol carboxymethylether (PSC) (100 g) as obtained in Example 1 was dissolved in 2000 ml of water at 65-70° C. Separately, iron solution was prepared by dissolving 75.3 g of ferric chloride hexahydrate and 37.7 g of ferrous chloride tetrahydrate in 400 ml of water at ambient temperature. The iron solution was added into the polyglucose sorbitol carboxymethylether (PSC) solution and kept at 65° C. to 70° C. Ammonium hydroxide solution (1200 g) was added to the reaction mass at 65° C. to 70° C. within 55 seconds and maintained at 65° C. to 70° C. temperature for 12 hours. The solution was cooled at 25° C. to 30° C. and purged with air for 30 minutes and filtered through 0.2-micron filter. Methanol was added under stirring at 43° C. to 47° C. to precipitate the solid ferumoxytol. The mixture was stirred for 60 minutes and cooled to 35° C. and filtered to get Ferumoxytol wet solid which was dried at 50° C. to 60° C. The dried solid Ferumoxytol (100 g) was added into the mixture of 1400 mL methanol and 600 mL water at room temperature. The mixture was stirred for 120 minutes and filtered to get pure solid Ferumoxytol, which was dried at 50° C. to 60° C. Dry wt.: 59.0 g. Molecular weight: 195000 Daltons; Polydispersity (PDI): 1.33.

### Example 6: Preparation of Ferumoxytol in Solid Form

Polyglucose sorbitol carboxymethylether (PSC) (100 g) as obtained in Example 2 was dissolved in 2000 ml of water at 45° C. Separately, iron solution was prepared by dissolving 37.5 g of ferric chloride hexahydrate and 18.7 g of ferrous chloride tetrahydrate in 400 ml of water at ambient temperature. The iron solution was added into the polyglucose sorbitol carboxymethylether (PSC) solution and kept at 45° C. to 50° C. Ammonium hydroxide solution (600 g) was added to the reaction at 75° C. to 80° C. within 10 minutes and maintained at 75° C. to 80° C. temperature for 2 hours. The solution was cooled to 25° C. to 30° C. and purged with air for 30 minutes and filtered through 0.2-micron filter. Methanol was added under stirring at 25° C. to 35° C. to precipitate the solid ferumoxytol. The mixture was stirred for 30 minutes and filtered to get Ferumoxytol wet solid which was dried at 50° C. to 60° C. Dry wt.: 46.5 g; Molecular weight: 367000 Daltons; Polydispersity (PDI): 1.88.

### Example 7: Purification of Solid Ferumoxytol

Solid Ferumoxytol (100 g) obtained in Example 4 was dissolved in 500 ml of water at room temperature. Isopropyl alcohol (1000 mL) was added into the solution under stirring at room temperature to precipitate the pure solid ferumoxytol. The mixture was stirred for 30 minutes and filtered to get pure solid Ferumoxytol, which was dried at 50° C. to 60° C. Dry wt.: 83.5 g.

### Example 8: Purification of Solid Ferumoxytol

Solid Ferumoxytol (100 g) obtained in Example 4 was dissolved in 500 ml of water at room temperature. Tetrahydrofuran (650 mL) was added into the solution under stirring at room temperature to precipitate the pure solid ferumoxytol. The mixture was stirred for 30 minutes and filtered to get pure solid Ferumoxytol, which was dried at 50° C. to 60° C. Dry wt.: 79.5 g.

### Example 9: Purification of Solid Ferumoxytol

Solid Ferumoxytol (100 g) as obtained in Example 4 was dissolved in 500 mL water at room temperature. Acetone (750 mL) was added into the solution under stirring at room temperature to precipitate the pure solid ferumoxytol. The mixture was stirred for 30 minutes and filtered to get pure solid Ferumoxytol, which was dried at 50° C. to 60° C. Dry wt.: 84.35 g.

### Example 10: Preparation of Ferumoxytol in Solid Form

Polyglucose sorbitol carboxymethylether (PSC) (100 g) obtained in Example 1 was dissolved in 2000 mL of water at 65-70° C. Separately, iron solution was prepared by dissolving 75.0 g of ferric chloride hexahydrate and 37.5 g of ferrous chloride tetrahydrate in 400 mL of water at ambient temperature. The iron solution was added into the polyglucose sorbitol carboxymethylether (PSC) solution and kept at 65° C. to 70° C. Ammonium hydroxide solution (1200 g) was added to the reaction at 65° C. to 70° C. within 45 seconds and maintained at 65° C. to 70° C. temperature for 12 hours. 730 mL of aqueous ammonium hydroxide was distilled out from the reaction mass and 730 ml of water was added. The mixture was purged with air for 30 minutes and filtered through 0.2-micron filter. Methanol was added under stirring at 25° C. to 35° C. to precipitate the solid ferumoxytol. The mixture was stirred for 30 minutes and filtered to get Ferumoxytol wet solid which was dried at 50° C. to 60° C. Dry wt.: 62.6 g; Molecular weight: 253000 Daltons; Polydispersity (PDI): 1.24.

### Example 11: Purification of Solid Ferumoxytol

Solid ferumoxytol (100 g) obtained in Example 10 was added into 2000 mL of methanol at room temperature. The mixture was stirred for 60 minutes and filtered to get pure solid ferumoxytol, which was dried at 50° C. to 60° C. Dry wt.: 89.0 g. Molecular weight: 249000 Daltons; Polydispersity (PDI): 1.24.

### Example 12: Gel Permeation Chromatography Data for FERAHEME®

Molecular weight and polydispersity of ferumoxytol sold under FERAHEME® brand were measured using gel permeation chromatography. The measured data are as follows: Molecular weight (Mw): 212000; Polydispersity (PDI): 1.33

### Example 13: Preparation of Ferumoxytol in Solid Form

Polyglucose sorbitol carboxymethylether (PSC) (100 g) obtained in example 1 was dissolved in 2000 ml of water at 65-70° C. Separately, iron solution was prepared by dissolving 75.3 g of ferric chloride hexahydrate and 37.7 g of ferrous chloride tetrahydrate in 400 ml of water at ambient temperature. The iron solution was added into the polyglucose sorbitol carboxymethylether (PSC) solution and kept at 65° C. to 70° C. Ammonium hydroxide solution (1200 g) was added to the reaction mass at 65° C. to 70° C. within 55 seconds and maintained at 65° C. to 70° C. temperature for 12 hours. The reaction mass was cooled and purged with air during cooling. pH of the reaction mass was adjusted to 7.0-7.5 using concentrated hydrochloride acid and the mass was filtered through 0.2-micron filter. Methanol was added under stirring at 43° C. to 47° C. to precipitate the solid ferumoxytol. The mixture was stirred for 60 minutes and cooled to 35° C. and filtered to get ferumoxytol wet solid, which was dried at 50° C. to 60° C. The dried solid ferumoxytol (100 g) was added into the mixture of 1400 mL methanol and 600 mL water at room temperature. The mixture was stirred for 120 minutes and filtered to get pure solid ferumoxytol, which was dried at 50° C. to 60° C. Dry wt.: 60.8 g. Molecular weight: 222000 Daltons; Polydispersity (PDI): 1.25.

### Example 14: Preparation of Ferumoxytol in Solid Form

Polyglucose sorbitol carboxymethylether (PSC) (100 g) obtained in example 1 was dissolved in 2000 mL of water at 65-70° C. Separately, iron solution was prepared by dissolving 75.3 g of ferric chloride hexahydrate and 37.7 g of ferrous chloride tetrahydrate in 400 ml of water at ambient temperature. The iron solution was added into the polyglucose sorbitol carboxymethylether (PSC) solution and kept at 65° C. to 70° C. Ammonium hydroxide solution (1200 g) was added to the reaction mass at 65° C. to 70° C. within 55 seconds and maintained at 65° C. to 70° C. temperature for 12 hours. The reaction mass was cooled and purged with air during cooling. pH of the reaction mass was adjusted to 4 to 6 and the mass was heated to 90° C. to 95° C. for 5 hours. The solution was cooled at 25° C. to 30° C. and pH of the reaction mass was adjusted to 8-9 by ammonium hydroxide solution and filtered through 0.2-micron filter. Methanol was added under stirring at 43° C. to 47° C. to precipitate the solid ferumoxytol. The mixture was stirred for 60 minutes and cooled to 35° C. and filtered to get ferumoxytol wet solid which was dried at 50° C. to 60° C. Dry wt.: 72.0 g. Molecular weight: 267000 Daltons; Polydispersity (PDI): 1.20.

### Example 15: Preparation of Ferumoxytol in Solid Form

Polyglucose sorbitol carboxymethylether (PSC) (100 g) obtained in example 1 was dissolved in 2000 ml of water at 65-70° C. Separately, iron solution was prepared by dissolving 75.3 g of ferric chloride hexahydrate and 37.7 g of ferrous chloride tetrahydrate in 400 ml of water at ambient temperature. The iron solution was added into the polyglucose sorbitol carboxymethylether (PSC) solution and kept at 65° C. to 70° C. Ammonium hydroxide solution (1200 g) was added to the reaction mass at 65° C. to 70° C. within 55 seconds and maintained at 65° C. to 70° C. temperature for 12 hours. The reaction mass was cooled and purged with air during cooling. pH of the reaction mass was adjusted to 4 to 6 and the mass was heated to 90° C. to 95° C. for 5 hours. The solution was cooled at 25° C. to 30° C. and pH of the reaction mass was adjusted to pH 8-9 by 50% sodium hydroxide solution and filtered through 0.2-micron filter. Methanol was added under stirring at 43° C. to 47° C. to precipitate the solid ferumoxytol. The mixture was stirred for 60 minutes and cooled to 35° C. and filtered to get ferumoxytol wet solid which was dried at 50° C. to 60° C. Dry wt.: 62.0 g. Molecular weight: 266000 Daltons; Polydispersity (PDI): 1.22.

It should be noted that the invention in its broader aspects is not limited to the specific details, representative compositions, methods, and processes, and illustrative examples described in connection with the preferred embodiments and preferred methods. Modifications and equivalents will be apparent to practitioners skilled in this art and are encompassed within the spirit and scope of the appended claims.

What is claimed is:

1. A process for preparation of a solid ferumoxytol, comprising the steps of:
a) reacting a carbohydrate with a mixture of iron salts;
b) adding ammonium hydroxide in about five minutes or less to obtain a ferumoxytol solution; and
c) treating the ferumoxytol solution with an organic solvent to obtain the solid ferumoxytol.

2. The process according to claim 1, wherein the ammonium hydroxide is added in about two minutes or less.

3. The process according to claim 1, wherein the solid ferumoxytol has polydispersity of less than about 1.4.

4. The process according to claim 1, further comprising the step of distilling out excess ammonium hydroxide and water from the ferumoxytol solution.

5. The process according to claim 1, further comprising the step of purifying the solid ferumoxytol by using a mixture of water and at least one water miscible organic solvent.

6. The process according to claim 5, wherein the purified solid ferumoxytol has an average molecular weight in a range from about 150,000 to about 270,000 Daltons.

7. The process according to claim 1, further comprising the step of purifying the solid ferumoxytol by dissolving the solid ferumoxytol in water, adding a water miscible organic solvent, and isolating a pure solid ferumoxytol.

8. The process according to claim 1, wherein the carbohydrate is polyglucose sorbitol carboxymethylether (PSC).

9. The process according to claim 1, wherein the iron salts are selected from ferric chloride, ferrous chloride, ferric nitrate, ferrous nitrate, ferric sulfate, ferrous sulfate, ferric bromide, ferrous bromide and mixtures thereof.

10. The process according to claim 9, wherein the iron salts are ferric chloride hexahydrate and ferrous chloride tetrahydrate.

11. The process according to claim 1, wherein the organic solvent is a water miscible organic solvent.

12. The process according to claim 11, wherein the water miscible organic solvent is selected from methanol, ethanol, isopropanol, acetone, acetonitrile, tetrahydrofuran, dioxane, dimethyl formamide, dimethylacetamide, N-methyl pyrrolidinone and mixtures thereof.

13. The process according to claim 5, wherein the at least one water miscible organic solvent is selected from methanol, ethanol, isopropanol, acetone, acetonitrile, tetrahydrofuran and mixtures thereof.

14. The process according to claim 1, further comprising the step of purifying the solid ferumoxytol by dissolving the solid ferumoxytol in water, adding a water miscible organic solvent, and isolating a pure solid ferumoxytol.

15. The process for purification of a solid ferumoxytol, comprising the steps of:
a) dissolving the solid ferumoxytol in water;
b) adding a water miscible organic solvent; and
c) isolating a pure solid ferumoxytol.

16. The process according to claim 15, wherein the water miscible organic solvent is selected from methanol, ethanol, isopropanol, acetone, acetonitrile, tetrahydrofuran and a mixture thereof.

17. A process for purification of a solid ferumoxytol, comprising the steps of:
a) combining water and water miscible organic solvent to make a solvent mixture;
b) adding the solid ferumoxytol into the solvent mixture; and
c) isolating a pure solid ferumoxytol.

18. The process according to claim 17, wherein the water miscible organic solvent is selected from methanol, ethanol, isopropanol, acetone, acetonitrile, tetrahydrofuran, and a mixture thereof.

19. The process according to claim 17, wherein the step of adding the solid ferumoxytol into the solvent mixture is performed at a temperature range from about 20° C. to about 60° C.
